(19) United States
(12) Patent Application Publication
(10) Pub. No.: US 2011/0239263 A1
(43) Pub. Date: Sep. 29, 2011

(54) METHOD AND APPARATUS FOR RECEIVING NON-REAL TIME CONTENT INCLUDED IN REAL TIME BROADCASTING SIGNAL

(75) Inventors: Mun-jo KIM, Suwon-si (KR); In-chul HWANG, Suwon-si (KR)

(73) Assignee: SAMSUNG ELECTRONICS CO., LTD., Suwon-si (KR)

(21) Appl. No.: 13/073,331

(22) Filed: Mar. 28, 2011

Related U.S. Application Data
(60) Provisional application No. 61/364,093, filed on Jul. 14, 2010.
(60) Provisional application No. 61/333,024, filed on May 10, 2010.
(60) Provisional application No. 61/317,901, filed on Mar. 26, 2010.

(30) Foreign Application Priority Data
Mar. 18, 2011 (KR) 10-2011-0024346

(51) Int. Cl. H04N 7/173

(52) U.S. Cl. 725/110

(57) ABSTRACT

A method and apparatus for downloading and storing non-real time content are provided. The apparatus includes a browser driver which drives a browser, and a storage unit. The browser includes a first interface for extracting information about a transmission schedule of non-real time content included in a real time broadcasting signal and transmitting the extracted information to an application, and a second interface for downloading the non-real time content according to a download request from the application based on the transmission schedule. The storage unit stores the non-real time content downloaded by the second interface.

### CROSS-REFERENCE TO RELATED PATENT APPLICATION

This application claims the benefit of U.S. Provisional Application Nos. 61/317,901, 61/333,024, and 61/364,093, filed on Mar. 26, 2010, May 10, 2010, and Jul. 14, 2010, respectively, in the U.S. Patent and Trademark Office, and claims priority from Korean Patent Application No. 10-2011-0024346, filed on Mar. 18, 2011 in the Korean Intellectual Property Office, the disclosures of which are herein incorporated by reference in their entirety.

### BACKGROUND

1. Field

Apparatuses and methods consistent with exemplary embodiments relate receiving content, and more particularly, to receiving content included in a digital broadcasting signal.

2. Description of the Related Art

As the convergence of broadcasting and communication is generalized, demands for a television (TV) capable of providing not only a high quality broadcasting service, but also a data communication service are increasing. Various data communication services are provided by using a digital broadcasting signal received by the TV for a broadcasting service.

### SUMMARY

Exemplary embodiments provide a method and apparatus for receiving content included in a real time broadcasting signal, and a computer readable recording medium having recorded thereon a program for executing the method.

According to an aspect of an exemplary embodiment, there is provided an apparatus for receiving content, the apparatus comprising a browser driver which drives a browser comprising a first interface for extracting information about a transmission schedule of non-real time content included in a real time broadcasting signal and transmitting the extracted information to an application, and a second interface for downloading the non-real time content according to a download request from the application based on the transmission schedule; and a storage unit which stores the non-real time content downloaded by the second interface.

The information about the transmission schedule may include at least one of a first uniform resource locator (URL) for specifying a transport stream of the non-real time content in the real time broadcasting signal, and a second URL about a content access descriptor including the first URL.

The application may transmit the second URL to the second interface to request the second interface to download the non-real time content.

The real time broadcasting signal may include an information table about the non-real time content, and the first interface may extract the information about the transmission schedule from the information table.

The first interface may transmit information about a total number of transmission schedules of non-real time content included in the real time broadcasting signal to the application, and upon receiving an index from the application, transmit information about a transmission schedule of non-real time content corresponding to the index to the application.

The second interface may determine whether it is possible to download the non-real time content according to the download request from the application, and notify the application about a result of determination.

The second interface may determine whether it is possible to download the non-real time content by determining at least one of whether a storage space for storing the non-real time content exists in the storage unit, and whether there is another transmission schedule overlapping with the transmission schedule of the non-real time content, and notify the application about the result of determination.

The browser may further include a third interface for accessing non-real time content that is already downloaded and stored in the storage unit.

According to an aspect of another exemplary embodiment, there is provided a method of receiving content, the method comprising downloading content by using a browser comprising a first interface for extracting information about a transmission schedule of non-real time content included in a real time broadcasting signal and transmitting the extracted information to an application, and a second interface for downloading the non-real time content according to a download request from the application based on the transmission schedule; and storing the non-real time content that is downloaded.

According to an aspect of another exemplary embodiment, there is provided a computer readable recording medium having recorded thereon a program for executing a method comprising downloading content by using a browser comprising a first interface for extracting information about a transmission schedule of non-real time content included in a real time broadcasting signal and transmitting the extracted information to an application, and a second interface for downloading the non-real time content according to a download request from the application based on the transmission schedule; and storing the non-real time content that is downloaded.

### BRIEF DESCRIPTION OF THE DRAWINGS

The above and/or other aspects will become more apparent by describing in detail exemplary embodiments with reference to the attached drawings in which:

FIG. 1 is a diagram of a system for providing a video on demand (VOD) service, according to an exemplary embodiment;

FIG. 2 is a block diagram of an apparatus for receiving content, according to an exemplary embodiment;

FIG. 3 is a block diagram of an application, a browser, and a middleware, according to an exemplary embodiment;

FIG. 4 is a flowchart illustrating a method of receiving content, according to an exemplary embodiment;

FIG. 5 is a flowchart illustrating a method of extracting information about a transmission schedule of non-real time content included in a real time broadcasting signal, according to an exemplary embodiment;

FIG. 6 illustrates information about a total number of transmission schedules of non-real time content included in a real time broadcasting signal, according to an exemplary embodiment;

FIGS. 7A through 7C respectively illustrate information about a transmission schedule of non-real time content included in a real time broadcasting signal, according to exemplary embodiments; and

FIGS. 8A through 8C are flowcharts illustrating methods of downloading content, according to exemplary embodiments.

### DETAILED DESCRIPTION

Hereinafter, exemplary embodiments will be described more fully with reference to the accompanying drawings, in which exemplary embodiments are shown.

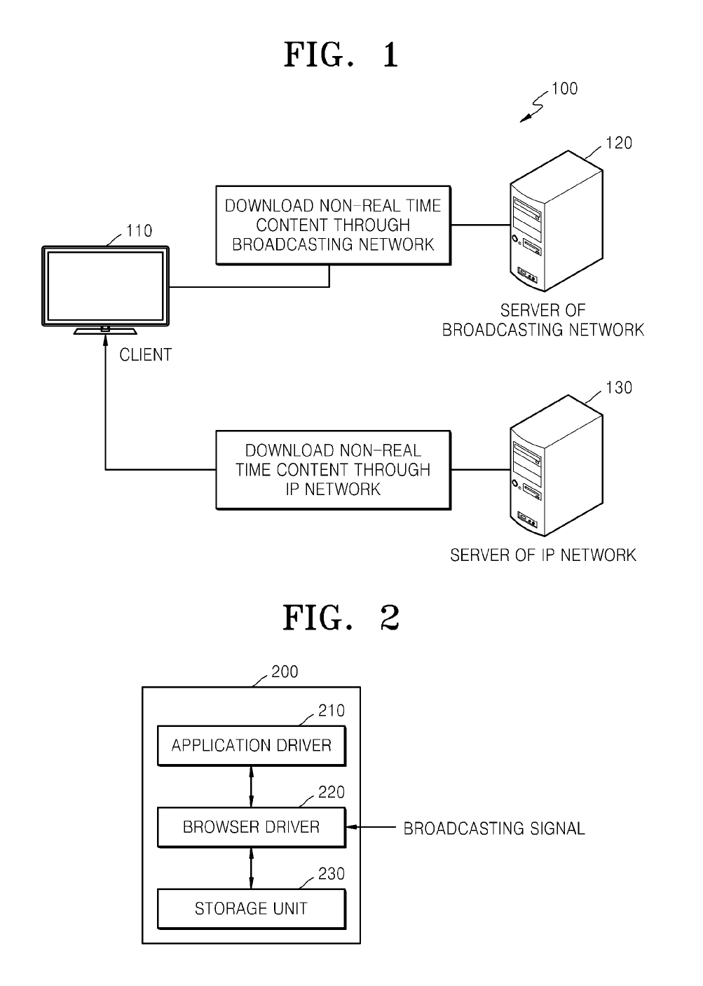

FIG. 1 is a diagram of a system 100 for providing a video on demand (VoD) service, according to an exemplary embodiment.

Referring to FIG. 1, in the system 100 according to the current exemplary embodiment, a client 110 may receive content via an Internet protocol (IP) network and a broadcasting network. The broadcasting network is a network for transmitting and receiving a digital broadcasting signal. When a tuner of the client 10 is tuned to a channel, the broadcasting network receives real time broadcasting content and non-real time content through a real time broadcasting signal transmitted and received through the channel.

The non-real time content may include an application or an audio-video (AV) content provided by a broadcaster, and the AV content may be a VoD transmitted and received through a broadcasting signal. According to a related art VoD service, the client 110 generally requests video content from a server 130 of the IP network, and receives the video content through the IP network in response to the request. A VoD service using a broadcasting signal is different from the related art VoD service because, in the VoD service using the broadcasting signal, when a server 120 of the broadcasting network transmits a broadcasting signal including video content at a given time regardless of a request of the client 110, the client 110 selectively extracts the video content from the broadcasting signal. Such a VoD service is referred to as a push VoD service.

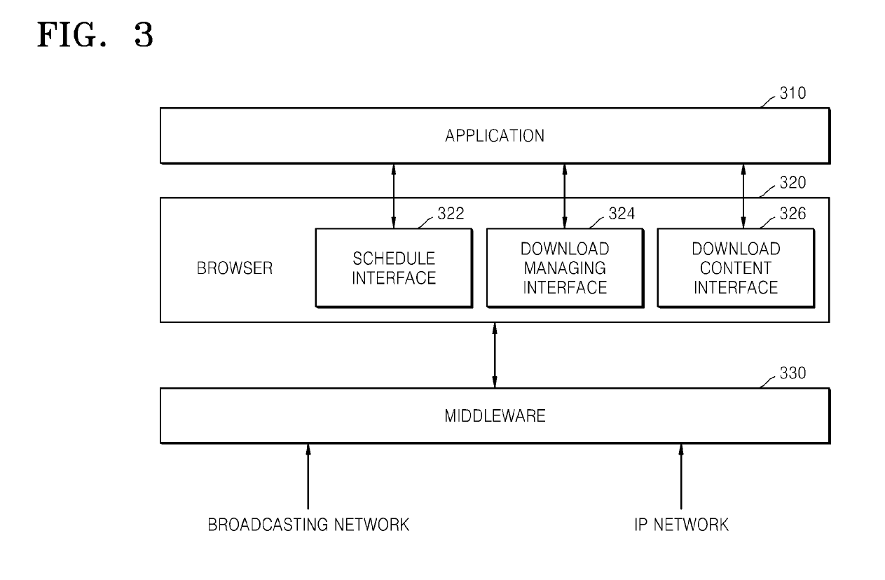

In order to use the push VoD service using the broadcasting signal, the client 110 includes a module for extracting information about a transmission schedule of video content included in the broadcasting signal, and a module for extracting and downloading the video content based on the extracted information. Also, in order for various applications to access the push VoD service, the client 110 includes a module that is not dependent on an application. Accordingly, a browser of the client 110 may include an interface for the various applications to access the push VoD service. The interface may be an application programming interface, which will be described in detail with reference to FIGS. 2 and 3.

FIG. 2 is a block diagram of an apparatus 200 for receiving content according to an exemplary embodiment.

Referring to FIG. 2, the apparatus 200 includes an application driver 210, a browser driver 220, and a storage unit 230.

The application driver 210 drives an application for using a service. An application driven by the application driver 210 may be an application for using the push VoD service described above. The application may be installed in the client 110 while manufacturing the client 110, or installed in the client 110 by receiving external data after manufacturing the client 110.

As described above, not only the real time broadcasting content, but also the non-real time content may be received through the broadcasting signal, and thus the client 110 may receive and install data about an application through the broadcasting signal. Alternatively, since the client 110 is also connected to the IP network, the client 110 may receive the data about the application through the IP network, install the received data and drive the application.

The browser driver 220 drives a browser providing an execution environment for the application driven by the application driver 210. The browser driver 220 may include various types of interfaces that are accessed by the application, and may perform a function as the application calls one of the various types of interfaces. The browser driver 220 may return a result of performance to the application.

As described above, the browser driven by the browser driver 220 may include an interface for receiving non-real time content included in a real time broadcasting signal. In detail, the browser may include at least one of a first interface for extracting information about a transmission schedule of the non-real time content included in the real time broadcasting signal and transmitting the extracted information to the application, and a second interface for downloading the non-real time content according to a download request of the application based on the extracted information, and a third interface for accessing non-real time content that is downloaded and stored in the storage unit 230.

The application driven by the application driver 210 may extract the information about the transmission schedule of the non-real time content included in the real time broadcasting signal through the first interface of the browser driven by the browser driver 220. The first interface extracts a transport stream corresponding to a non-real time information table from among transport streams of the real time broadcasting system, and extracts the information about the transmission schedule of the non-real time content included in the extracted transport stream.

The information about the transmission schedule may include at least one of a start time of transmitting non-real time content, time required for download, a cycle of retransmitting non-real time content, a number of retransmissions, an identifier (ID) of transmitted non-real time content, a title, a size, an available period, a uniform resource locator (URL), and a URL of a content access descriptor (CAD). The CAD may follow an Open Internet Protocol Television (IPTV) Forum (OIPF), and may include metadata such as a URL of the non-real time content, a synopsis, or a video/audio compression method.

Since the CAD includes the URL of the non-real time content, the application may download the non-real time content even if the first interface transmits the URL of the CAD as the information about the transmission schedule.

Accordingly, the information about the transmission schedule transmitted from the first interface to the application may include at least one of a first URL for specifying a transport stream of the non-real time content in the real time broadcasting signal, and a second URL for specifying a transport stream of the CAD in the real time broadcasting signal. When the first interface only transmits the second URL of the CAD to the application, the application transmits the second URL to the second interface that is described later, and the second interface downloads and transmits the CAD to the application based on the second URL. The application transmits the first URL included in the downloaded CAD again to the second interface to request to download the non-real time content.

According to another exemplary embodiment, when the application requests for the information about the transmission schedule, the first interface may transmit information about a total number of transmission schedules to the application. For push VoD service, the information about the total number of transmission schedules transmitted through the real time broadcasting signal, i.e., information about a total number of non-real time contents included in the real time broadcasting signal, is transmitted first. Then, when the application, upon receiving the information about the total number of the transmission schedules, requests information about one transmission schedule selected from among the transmission schedules, the first interface transmits information about the selected transmission schedule to the application. The application may request the information about the selected transmission schedule by transmitting an index corresponding to the selected transmission schedule to the first interface.

According to another exemplary embodiment, the first interface may receive the information about the transmission schedule of the non-real time content included in the real time broadcasting signal through the IP network, instead of the broadcasting network. Thus, even though the non-real time content is included in the real time broadcasting signal, the information about the transmission schedule need not necessarily be extracted from the real time broadcasting signal, and the information about the transmission schedule may be received through the IP network.

Upon receiving the information about the transmission schedule of the non-real time content from the first interface, the application requests the second interface of the browser to download the non-real time content based on the received information. The application may request the second interface to download the non-real time content by transmitting the first URL of the non-real time content included in the information about the transmission schedule to the second interface. Alternatively, when the information about the transmission schedule only includes the second URL of the CAD, the second URL of the CAD is transmitted to the second interface so that the CAD is first downloaded, and then the first URL of the non-real time content included in the downloaded CAD is transmitted again to the second interface so that non-real time content is requested to be downloaded.

Both the first URL and the second URL are URLs for respectively specifying transport streams corresponding to the non-real time content and the CAD in the real time broadcasting signal. Accordingly, the first and second URLs may have a format such as “nrt://{atsc_tsID}.{atsc_program_number}.{nrt_service_id}/{nrt_content_linkage}[/{file name}]”. Here, “atsc_tsID” denotes an ID of a channel to which a tuner of the client 110 is tuned, and “atsc_program_number” denotes a program ID defined in a program association table (PAT) or a terrestrial virtual channel table (TVCT) about the channel identified by “atsc_tsID”. The “nrt_service_id” denotes an ID of a non-real time service using a broadcasting signal, and may be an ID of a push VoD service defined in a non-real time information table. The “nrt_content_linkage” denotes a content linkage of the transport stream corresponding to the non-real time content or the CAD. The “file name” denotes a file name of the non-real time content or the CAD. The “file name” is optional.

The CAD may be an extensible markup language (XML) document including metadata about the non-real time content. When the XML document is received as the CAD, information about a media type defined in the non-real time information table may be referred to for the second interface to check that the received XML document is the CAD. If the media type of the non-real time information table is defined in “application/vnd.ohtv.ContetnAccessDownload+xml”, the received XML document is the CAD.

When the application requests the second interface to download the non-real time content, the application may transmit other information used to download the non-real time content, along with URL information. For example, the application may transmit information about a start time of transmitting the non-real time content to the second interface by referring to the information about the transmission schedule, and transmit information about a type of the non-real time content to be downloaded to the second interface so that the second interface accurately downloads the non-real time content.

Upon receiving information used to download the non-real time content from the application, the second interface requests a middleware supporting access to the broadcasting network and the IP network to download the non-real time content, and stores the non-real time content downloaded through the middleware in the storage unit 230.

The second interface may transmit the first URL of the non-real time content to the middleware to request the middleware to download the non-real time content. Alternatively, the second interface may transmit the second URL of the CAD, and receive the CAD. Upon receiving the CAD, the second interface transmits the CAD to the application, and relay the first URL of the non-real time content included in the CAD from the application to the middleware so as to request the middleware to download the non-real time content.

As described above, the second interface may download the non-real time content through the broadcasting network. However, the second interface may also download the non-real time content, such as VoD content, through the IP network. When the application requests the download of non-real time content, the application may notify the second interface whether the non-real time content is downloaded through the broadcasting network or the IP network so as to control the downloading of the second interface.

When the non-real time content is downloaded through the second interface, the application may access the downloaded non-real time content through the third interface of the browser. When the third interface transmits a list of the downloaded non-real time contents along with IDs respectively corresponding to the downloaded non-real time contents to the application, the application may use the non-real time content by referring to the list.

Since the second interface downloads the non-real time content not only through the broadcasting network, but also through the IP network, the third interface may generate a list including an indicator indicating whether the non-real time content is downloaded through the broadcasting network or the IP network, and transmit the list to the application.

Referring back to FIG. 2, the storage unit 230 stores the non-real time content downloaded through the second interface described above. At least one of the non-real time content downloaded through the broadcasting network and the non-real time content downloaded through the IP network may be stored in the storage unit 230. The storage unit 230 may assign an ID to the downloaded non-real time content, and store the non-real time content with the ID.

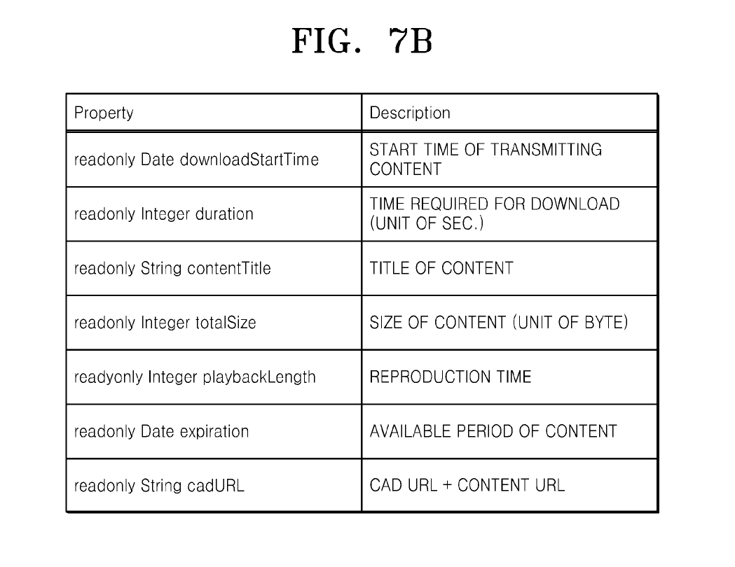

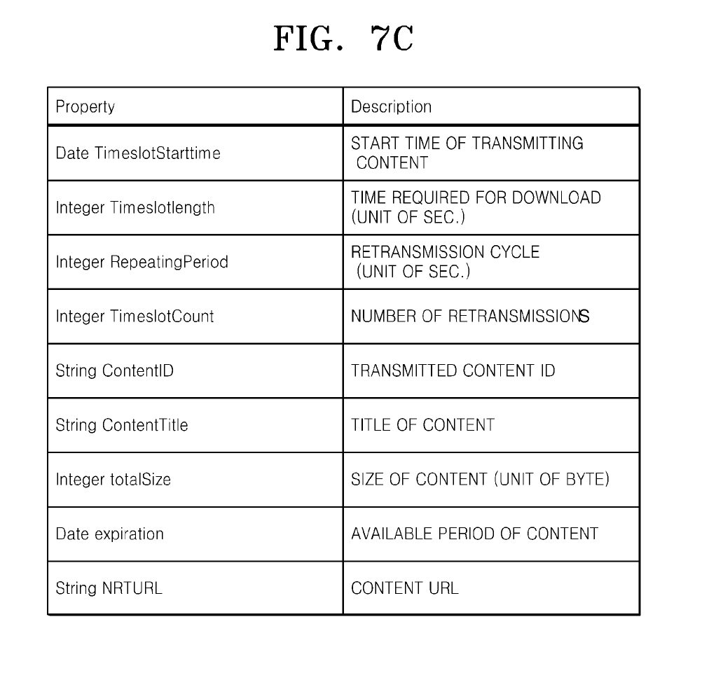

An ID identical to a content ID defined by the CAD may be assigned to the non-real time content. Alternatively, an ID identical to a content ID defined in the information about the transmission schedule may be assigned to the non-real time content, as will be described later with reference to FIG. 7C. However, when a content ID is not defined, the browser may arbitrarily generate and assign an ID.

FIG. 3 is a block diagram of an application 310, a browser 320, and a middleware 330, according to an exemplary embodiment.

Referring to FIG. 3, the application 310 driven by the application driver 210 may download non-real time content included in a real time broadcasting signal by using a schedule interface 322, a download managing interface 324, and a download content interface 326 included in the browser 320. The schedule interface 322 corresponds to the first interface for extracting and transmitting the information about the transmission schedule of the non-real time content included in the real time broadcasting signal to the application 310, the download managing interface 324 corresponds to the second interface for downloading the non-real time content according to the download request of the application 310 based on the extracted information, and the download content interface 326 corresponds to the third interface for accessing the non-real time content downloaded and stored in the storage unit 230.

The application 310 obtains the information about the transmission schedule of the non-real time content included in the non-real time information table of the real time broadcasting signal through the schedule interface 322. The schedule interface 322 extracts the information about the transmission schedule of the non-real time content from the real time broadcasting signal received through the broadcasting network. Also, the schedule interface 322 may receive the information about the transmission schedule of the non-real time content included in the real time broadcasting signal by connecting to a server of a broadcasting network through an IP network instead of the broadcasting network.

The application 310 triggers the downloading of the non-real time content using the download managing interface 324. The application 310 transmits the information about the transmission schedule received through the schedule interface 322 to the download managing interface 324 to request the download managing interface 324 to download the non-real time content. As described above, the application 310 transmits the first URL of the non-real time content or the second URL of the CAD to the download managing interface 324 to request the download managing interface 324 to download the non-real time content.

The download managing interface 324 downloads the non-real time content based on the information received from the application 310. The download managing interface 324 may download the non-real time content included in the real time broadcasting signal or the non-real time content through the IP network by using the middleware 330.

The downloaded non-real time content is stored in the storage unit 230, and the application 310 may use the stored non-real time content through the download content interface 326. The download content interface 326 may transmit the list of non-real time contents stored in the storage unit 230 to the application 310 according to a request of the application 310, and at this time, the list may include an indicator indicating whether the non-real time content is downloaded through the broadcasting network or the IP network.

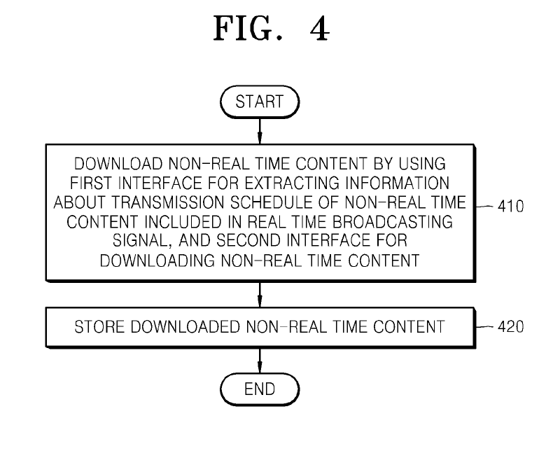

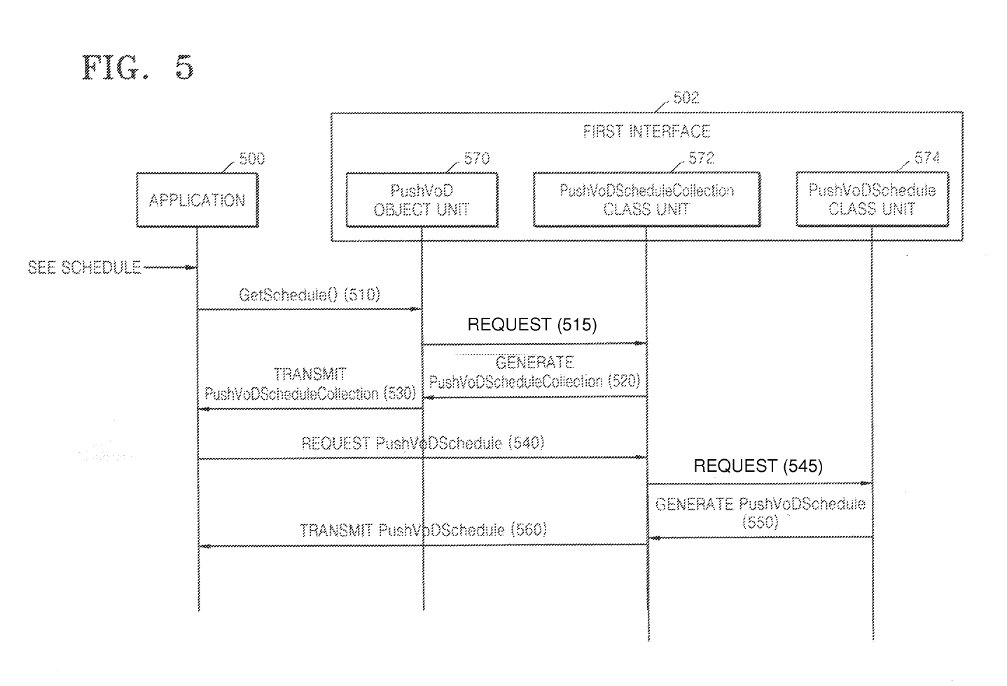

FIG. 4 is a flowchart illustrating a method of receiving content, according to an exemplary embodiment.

Referring to FIG. 4, the apparatus 200 downloads non-real time content by using the first and second interfaces described above, in operation 410. The non-real time content is downloaded by using the first interface for extracting the information about the transmission schedule of the non-real time content from the real time broadcasting signal, and the second interface for downloading the non-real time content based on the extracted information.

The apparatus 200 stores the non-real time content downloaded by using the first and second interfaces, in operation 420.

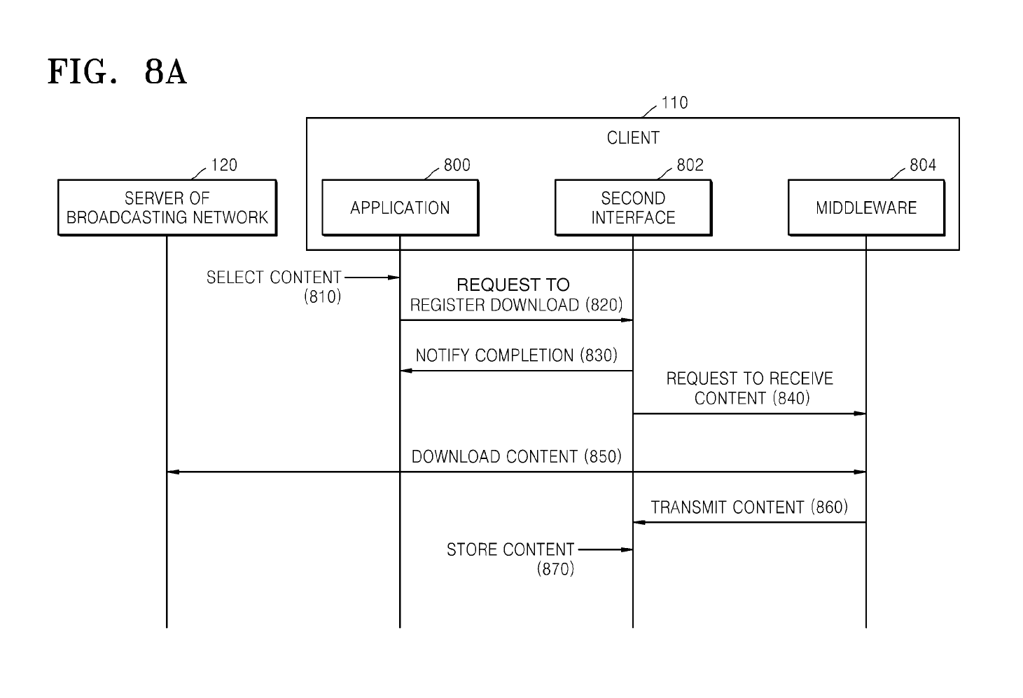

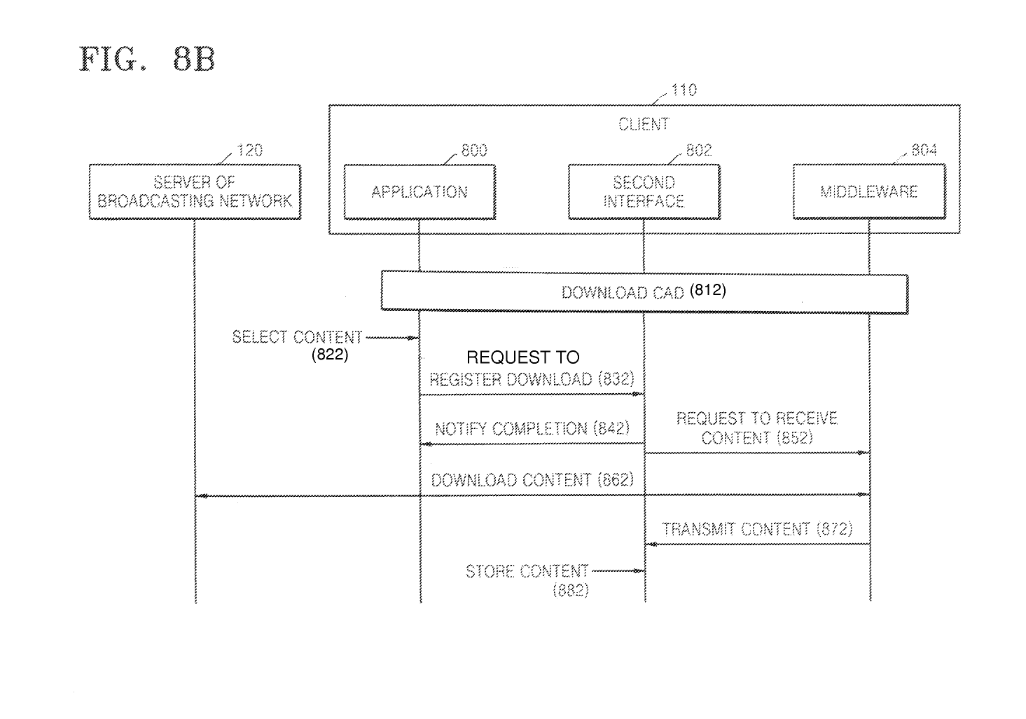

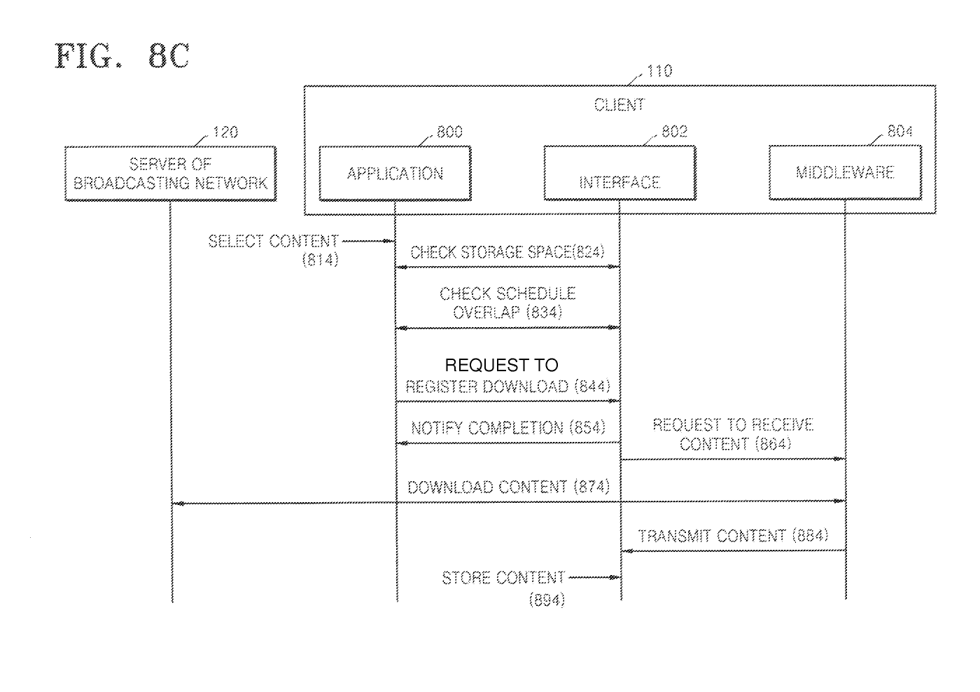

Operation 410 will be described in detail with reference to FIGS. 5 and 8A through 8C.

FIG. 5 is a flowchart illustrating a method of extracting information about a transmission schedule of non-real time content included in a real time broadcasting signal, according to an exemplary embodiment.

Referring to FIG. 5, a first interface 502 used by an application 500 to extract the information about the transmission schedule of the non-real time content from the real time broadcasting signal may include a PushVoD object unit 570, a PushVODScheduleCollection class unit 572, and a PushVoDSchedule class unit 574.

In operation 510, the application 500 calls the first interface 502 to extract the information about the transmission schedule of the non-real time content from the real time broadcasting signal. The application 500 may call the first interface 502 by transmitting a “GetSchedule( )” message.

Upon receiving the “GetSchedule( )” message from the application 500, the PushVoD object unit 570 requests information (operation 515) about a total number of transmission schedules to the PushVoDScheduleCollection class unit 572. The PushVoDScheduleCollection class unit 572 generates and transmits a class (operation 520) regarding the information about the total number of transmission schedules of the non-real time content transmitted through the real time broadcasting signal to the PushVoD object unit 570.

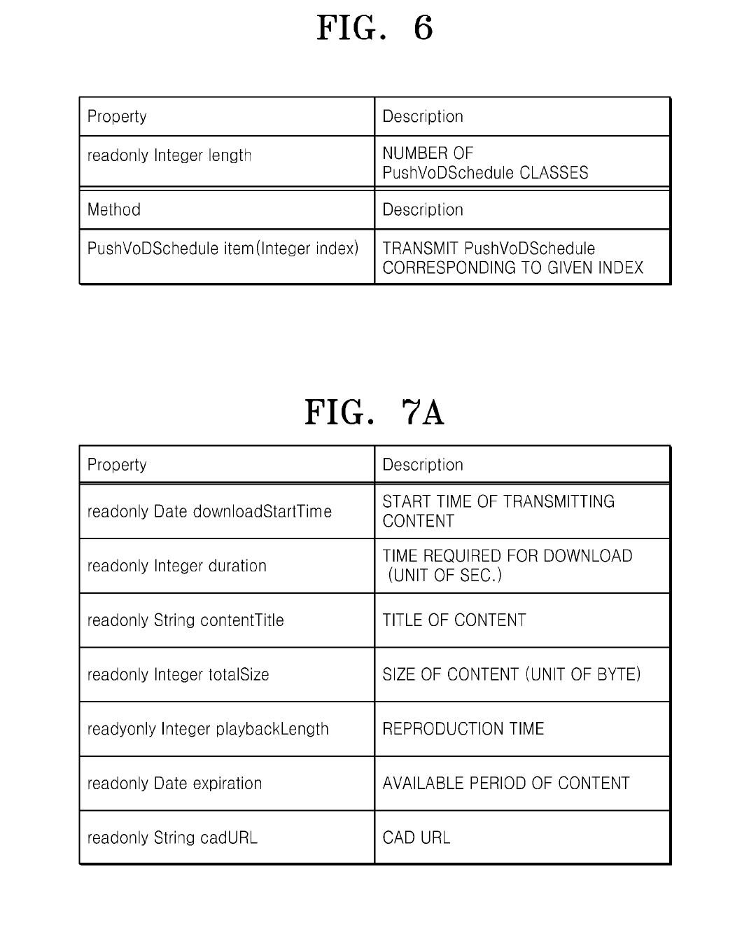

FIG. 6 illustrates information about a total number of transmission schedules of non-real time content included in a real time broadcasting signal, according to an exemplary embodiment. In detail, FIG. 6 is a table defining a class regarding the total number of transmission schedules.

Referring to FIGS. 5 and 6, a PushVoDScheduleCollection class generated by the PushVoDScheduleCollection class unit 572 and transmitted to the PushVoD object unit 570 in operation 520 includes a property defining a value of the total number of transmission schedules. Also, the PushVoDScheduleCollection class includes a method for calling a PushVoDSchedule class that will be described later. When the method included in the PushVoDScheduleCollection class is called, “index” is set as a variable so that the PushVoDSchedule class about one of the transmission schedules is called.

Referring back to FIG. 5, upon receiving the PushVoDScheduleCollection class from the PushVoDScheduleCollection class unit 572, the PushVoD object unit 570 transmits the received PushVoDScheduleCollection class to the application 500, in operation 530.

Upon receiving the PushVoDScheduleCollection class from the PushVoD object unit 570, the application 500 determines the total number of the transmission schedules based on the property included in the PushVoDScheduleCollection class, and requests the PushVoDScheduleCollection class unit 572 for a PushVoDSchedule class regarding a transmission schedule in operation 540. The PushVoDSchedule class is requested by using the method included in the PushVoDScheduleCollection class. As described above, the “index” corresponding to one of the transmission schedules may be set to call the method, thereby requesting the PushVoDSchedule class.

Upon receiving the request for the PushVoDSchedule class, the PushVODScheduleCollection class unit 572 requests for the PushVoDSchedule class (operation 545) to the PushVoDSchedule class unit 574. The PushVoDSchedule class unit 574 then generates the PushVoDSchedule class and transmits the PushVoDSchedule class back to the PushVoDScheduleCollection class unit 572 in operation 550, and the PushVoDScheduleCollection class unit 572, in turn, transmits the PushVoDSchedule class received in response to the request to the application 500 in operation 560.

Upon receiving the PushVoDSchedule class, the application 500 may obtain information about a first URL of the non-real time content, a start time of downloading the non-real time content, a size of the non-real time content, etc., based on the PushVoDSchedule class.

FIGS. 7A through 7C respectively illustrate information about a transmission schedule of non-real time content included in a real time broadcasting signal, according to exemplary embodiments. In detail, FIGS. 7A through 7C are each tables defining a class regarding a transmission schedule of non-real time content.

Referring to FIG. 7A, the class regarding the transmission schedule, i.e., a PushVoDSchedule class, may include a start time of transmitting the non-real time content, a time required to download the non-real time content, a size of the non-real time content, a reproduction time of the non-real time content, an available period of the non-real time content, and a second URL of a CAD. The information about the transmission schedule in FIG. 7A includes the second URL of the CAD, wherein the CAD includes a first URL of the non-real time content.

Alternatively, the class regarding the transmission schedule may not only include the second URL of the CAD, but also include the first URL of the non-real time content as shown in FIG. 7B, or may only include the first URL of the non-real time content as shown in FIG. 7C. Even when only the second URL of the CAD is included in the information about the transmission schedule, an application that receives the information about the transmission schedule may extract the first URL of the non-real time content from the CAD. Also, when the same non-real time contents are repeatedly transmitted through the real time broadcasting signal, the PushVoDSchedule class shown in FIG. 7C further includes information about a cycle of retransmission, a number of retransmissions, and an identification (ID) of content set by a server of a broadcasting network.

When the PushVoDSchedule class shown in one of FIGS. 7A through 7C is transmitted to the application, the application may determine the first URL of the non-real time content, and request a second interface to download the non-real time content based on other information, such as a start time of transmission, a type of the non-real time content, etc. included in the PushVoDSchedule class.

FIGS. 8A through 8C are flowcharts illustrating methods of downloading content, according to exemplary embodiments. Upon extracting information about a transmission schedule of non-real time content according to the method of FIG. 5, an application 800 triggers downloading of the non-real time content according to the method shown in any one of FIGS. 8A through 8C.

Referring to FIG. 8A, the application 800 driven in the client 110 selects non-real time content based on information about a transmission schedule of non-real time content, which is extracted from a real time broadcasting signal, in operation 810. One of a plurality of non-real time contents that may be downloaded through the real time broadcasting signal may be selected.

Information about transmission schedules of the plurality of non-real time contents is displayed to a user through a display device, such as a display panel of a TV, of the client 110, and one non-real time content may be selected based on the transmission schedule of the non-real time contents.

When the non-real time content is selected, the application 800 requests a second interface 802 to register the download of the selected non-real time content, in operation 820. The second interface 802 may be the download managing interface 324 described above with reference to FIG. 3.

In operation 820, the request may include registering the download. In order to register the downloading of the non-real time content, the application 800 may transmit a message in a “registerDownloadURL (URL, contentType, downloadStartTime)” format to the second interface 802.

“registerDownloadURL” denotes a message for registering reception of the non-real time content included in the real time broadcasting signal received through a broadcasting network. “URL” is set as a first URL of the non-real time content, and “downloadStartTime” is set as a start time of downloading the non-real time content.

“contentType” is set as a multipurpose internet mail extensions (MIME) type of the non-real time content received through the real time broadcasting signal. The MIME type may be set to indicate that the non-real time content to be downloaded is received through the real time broadcasting signal. For example, the MIME type may be set as “application/ohtv-pushvod” to indicate that the non-real time content is a push VoD.

According to another exemplary embodiment, the application 800 may transmit a “registerPushVoDDownload (PushVoDSchedule vinfo)” message to request the second interface 802 to register downloading of the non-real time content. As described with reference to FIG. 3, the second interface 802 not only manages downloading of the non-real time content through the broadcasting network, but also manages downloading of the non-real time content through an IP network. Accordingly, when requesting the second interface 802 to download the non-real time content, the application 800 may transmit a message separately defined for downloading of the non-real time content through the broadcasting network to the second interface 802. “registerPushVoDDownload” is the separately defined message, and is transmitted to the second interface 802, along with the information about the transmission schedule, thereby registering the downloading of the non-real time content.

When the registering of downloading is completed, the second interface 802 notifies the completion to the application 800, in operation 830.

After the registering of downloading is completed and it is time to download the non-real time content, the second interface 802 requests a middleware 804 to receive the non-real time content, in operation 840. The non-real time content that is registered to be downloaded in operation 820 is requested.

The middleware 804 downloads the requested non-real time content in operation 850. The non-real time content included in the real time broadcasting signal transmitted by the server 120 of the broadcasting network is downloaded. A transport stream corresponding to the non-real time content included in the real time broadcasting signal is received.

The received non-real time content is transmitted to the second interface 802 in operation 860, and the second interface 802 stores the non-real time content in a storage device in operation 870.

The method of FIG. 8B differs from the method of FIG. 8A in that the method of FIG. 8B further includes receiving a CAD in operation 812. As described above, the first URL of the non-real time content included in the real time broadcasting signal may be included in the CAD. In this case, the application 800 first downloads the CAD in operation 812, based on the second URL of the CAD included in the information about the transmission schedule of the non-real time content. When the first URL of the non-real time content included in the downloaded CAD is obtained, operations 822 through 882 are performed based on the obtained first URL of the non-real time content. Operations 822 through 882 correspond to operations 810 through 870 of FIG. 8A. In other words, operations 822 through 882 are respectively identical to operations 810 through 870.

Referring to FIG. 8C, the application 800 driven in the client 110 selects non-real time content based on information about a transmission schedule of non-real time contents extracted from a real time broadcasting signal, in operation 814. Operation 814 is identical to operation 810 of FIG. 8A.

The application 800 checks whether the client 110 includes a storage space for storing the non-real time content selected in operation 814, by using the second interface 802, in operation 824. The application 800 may check whether the storage space exists by transmitting a “Integer checkDownloadPossible (Integer sizeInBytes)” message to the second interface 802. The application 800 may determine a size of the non-real time content selected in operation 814 based on the information about the transmission schedule, and transmit a “checkDownloadPossible” message to the second interface 802 by setting “sizeInBytes” as the size of the selected non-real time content.

The second interface 802 may check a storage device of the client 110 to determine whether the storage space exists, and return information about the storage space to the application 800, in an integer value.

When it is determined that the client 110 has the storage space in operation 824, the application 800 checks whether a download schedule overlaps in operation 834. When the client 110 receives the real time broadcasting signal, the tuner of the client 110 is tuned to a predetermined channel. Accordingly, when non-real time content is downloaded through a first channel, another non-real time content cannot be downloaded through a second channel.

Accordingly, the client 110 checks whether the other non-real time content is to be downloaded while downloading the selected non-real time content. The application 800 checks the overlapping of the download schedule by transmitting a “checkPushVoDDownloadPossible (PushVoDSchedule vinfo)” message to the second interface 802. The application 800 transmits the PushVoDSchedule class, i.e., the information about the transmission schedule, to the second interface 802, and the second interface 802 may check the overlapping of the download schedule by referring to the information.

Operations 844 through 894 correspond to operations 820 through 870 of FIG. 8A. In other words, operations 844 through 894 are respectively identical to operations 820 through 870 of FIG. 8A.

According to exemplary embodiments, the non-real time content included in the real time broadcasting signal can be accurately downloaded, and thus it is possible to provide a VoD service through the real time broadcasting signal. Also, since the non-real time content is downloaded after pre-checking whether the non-real time content can be stored, malfunction of the client may be prevented.

The present inventive concept can also be embodied as computer readable codes on a computer readable recording medium.

For example, the apparatus for receiving content may include a bus coupled to each element of the apparatus shown in FIG. 1, and at least one central processing unit (CPU) coupled to the bus. Also, the apparatus may include a memory coupled to the at least one CPU that is combined to the bus to store a received or generated message, and performs commands described above.

The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present inventive concept has been particularly shown and described with reference to exemplary embodiments thereof, it will be understood by those of ordinary skill in the art that various changes in form and details may be made therein without departing from the spirit and scope as defined by the following claims.

What is claimed is:

1. An apparatus for receiving content, the apparatus comprising:
a browser driver which drives a browser comprising:
a first interface for extracting information about a transmission schedule of non-real time content included in a real time broadcasting signal and transmitting the extracted information to an application, and
a second interface for downloading the non-real time content according to a download request from the application based on the transmission schedule; and
a storage unit which stores the non-real time content downloaded by the second interface.

2. The apparatus of claim 1, wherein the information about the transmission schedule comprises at least one of a first uniform resource locator (URL) for specifying a transport stream of the non-real time content in the real time broadcasting signal, and a second URL about a content access descriptor including the first URL.

3. The apparatus of claim 2, wherein the application transmits the second URL to the second interface to request the second interface to download the non-real time content.

4. The apparatus of claim 2, wherein the real time broadcasting signal includes an information table about the non-real time content, and
the first interface extracts the information about the transmission schedule from the information table.

5. The apparatus of claim 1, wherein the first interface transmits information about a total number of transmission schedules of non-real time content included in the real time broadcasting signal to the application, and upon receiving an index from the application, transmits information about a transmission schedule of non-real time content corresponding to the index to the application.

6. The apparatus of claim 1, wherein the second interface determines whether it is possible to download the non-real time content according to the download request from the application, and notifies the application about a result of the determination.

7. The apparatus of claim 6, wherein the second interface determines whether it is possible to download the non-real time content by determining at least one of whether a storage space for storing the non-real time content exists in the storage unit, and whether there is another transmission schedule overlapping with the transmission schedule of the non-real time content.

8. The apparatus of claim 1, wherein the browser further comprises a third interface for accessing non-real time content that is already downloaded and stored in the storage unit.

9. A method of receiving content, the method comprising:
downloading content by using a browser comprising:
a first interface for extracting information about a transmission schedule of non-real time content included in a real time broadcasting signal and transmitting the extracted information to an application, and
a second interface for downloading the non-real time content according to a download request from the application based on the transmission schedule; and
storing the non-real time content that is downloaded by the second interface.

10. The method of claim 9, wherein the information about the transmission schedule comprises at least one of a first uniform resource locator (URL) for specifying a transport stream of the non-real time content in the real time broadcasting signal, and a second URL about a content access descriptor including the first URL.

11. The method of claim 10, wherein the application transmits the second URL to the second interface to request the second interface to download the non-real time content.

12. The method of claim 10, wherein the real time broadcasting signal includes an information table about the non-real time content, and
the first interface extracts the information about the transmission schedule from the information table.

13. The method of claim 9, wherein the first interface transmits information about a total number of transmission schedules of non-real time content included in the real time broadcasting signal to the application, and upon receiving an index from the application, transmits information about a transmission schedule of non-real time content corresponding to the index to the application.

14. The method of claim 9, wherein the second interface determines whether it is possible to download the non-real time content according to the download request from the application, and notifies the application about a result of the determination.

15. The method of claim 14, wherein the second interface determines whether it is possible to download the non-real time content by determining at least one of whether a storage space for storing the non-real time content exists in the storage unit, and whether there is another transmission schedule overlapping with the transmission schedule of the non-real time content, and notifies the application about the result of determination.

16. The method of claim 9, wherein the browser further comprises a third interface for accessing non-real time content that is already downloaded and stored.

17. A computer readable recording medium having recorded thereon a program for executing a method comprising:
downloading content by using a browser comprising:
a first interface for extracting information about a transmission schedule of non-real time content included in a real time broadcasting signal and transmitting the extracted information to an application, and
a second interface for downloading the non-real time content according to a download request from the application based on the transmission schedule; and
storing the non-real time content that is downloaded by the second interface.

18. The apparatus of claim 1, wherein the application is driven by a client.
